(19) United States
(12) Patent Application Publication
(10) Pub. No.: US 2004/0197118 A1
(43) Pub. Date: Oct. 7, 2004

(54) Replenishment receptacle for an electrostatographic reproduction apparatus

(75) Inventors: Terry Richard Elich, Pittsford, NY (US); Michelle Dawn Wise, Hamlin, NY (US); Scott Thomas Slattery, Brockport, NY (US); Theodore Kenneth Ricks, Rochester, NY (US); Thomas Daniel Jensen, Rochester, NY (US)

Correspondence Address: Lawrence P. Kessler, Patent Department, NexPress Solutions LLC, 1447 St. Paul Street, Rochester, NY, 14653-7103, US

(73) Assignees: NexPress Solutions LLC; Eastman Kodak Company

(21) Appl. No.: 10/774,897

(22) Filed: Feb. 9, 2004

Related U.S. Application Data
(60) Provisional application No. 60/460,331, filed on Apr. 3, 2003.

(51) Int. Cl. G03G 15/08

(52) U.S. Cl. 399/258; 399/262

(57) ABSTRACT

A replenishment receptacle for containing particulate material and replenishing the particulate material into a reservoir. The replenishment receptacle includes an enclosed container with an orifice for filing and removing particulate material and a closure with a slide cover for closing and sealing the container. Tab-like features on the closure, for locating it to the reservoir during transfer of the particulate material from the receptacle to the reservoir, are uniquely shaped and located for low cost manufacturing. The slide cover for closing and sealing the receptacle has a cellular urethane foam gasket bonded to the inner side and ramp-like features on the outer side to capture the slide cover, thus preventing it from being removed from the closure. In one embodiment the enclosed container and closure have features which engage and lock together the enclosed container and closure, thus preventing them from working loose and leaking during shipping and handling.

### FIELD OF THE INVENTION

This invention relates to image development in electrostatographic reproduction apparatus, and more particularly to receptacles for transporting and replenishing toner used in electrostatographic development stations.

### BACKGROUND OF THE INVENTION

Electrostatographic reproduction apparatus utilize toner particles dispensed from a development station to develop latent electrostatic images on image-bearing members such as, for example, photoconductors. Developments stations typically include a reservoir of toner particles that are fed, upon demand, into an active section of the development station. In some cases, the receptacle in which the toner particles are packaged for shipment is also the reservoir, being attached to the development station, opened to the development station by a slide cover which is part of the receptacle, and remaining on the development station until the contained toner particles are depleted. In higher volume reproduction apparatus, the desirable large size of the reservoir makes it impractical to use the shipping receptacle as the reservoir due to such large size. In this case, the reservoir is permanent in the reproduction apparatus and is replenished, as needed, by emptying the toner particle shipping receptacles into the reservoir.

Replenishing toner particles can be a messy and expensive procedure due to the nature of toner particles, which usually consist of very fine thermoplastic particles pigmented with carbon black or coloring pigments. These particles are susceptible to forming powder clouds if blown or aerated. Blowing or aeration can easily result when handling toner receptacles, which are usually flexible, so that the particles are aerated when the receptacle is squeezed. Toner particles are also frequently surface treated with silica or other similar additives that lowers their cohesiveness and improves their flow properties. Aerating surface treated toner particles can result in their flowing like a liquid and, as a result, they will leak out of the smallest cracks or openings in a receptacle. Not only are toner particle clouds messy, they can also cause maintenance problems if deposited on sensitive components of the reproduction apparatus.

In light of the above, it is a challenge to create a toner particle receptacle that does not leak during shipping and handling, or during the process of transferring the toner particles from the receptacle to the development station reservoir. Typically toner particle receptacles include some type of closure, which seals the receptacle during shipping and handling, can be attached to the development station reservoir, and then opened to enable transfer of the toner particles from the receptacle to the reservoir. The literature includes a number of patents directed to such a concept. Exemplary of such patents are U.S. Pat. Nos. 5,207,353; Des. 373,787; and Des. 374,249. It is a further challenge to keep the cost of producing the receptacle low enough so that it is not a major contributor to the overall cost of the toner.

### SUMMARY OF THE INVENTION

It is the object of this invention to provide a low cost toner particle receptacle, for shipping and for replenishing toner particles into an electrostatographic reproduction apparatus development station reservoir, with features for both lowering the manufacturing cost and preventing any leakage during shipping and handling or during replenishment of the reservoir. In a preferred embodiment of this invention, the receptacle includes a container having an orifice for filling it with toner. The orifice has a threaded flange for attaching a sealing closure, which has a slide cover with a cellular urethane foam gasket. A feature protruding from the threaded flange, adjacent to the threads, locks into a notch in the sealing closure, thus locking the closure in place on the container, and preventing the closure from working loose from the container and leaking during shipping. The sealing closure has protruding features for locating it relative to the reservoir in the reproduction apparatus. The protruding features on the sealing closure are uniquely shaped, which allows the closure to be produced by an injection molding process in which the mold consists of only two separable parts. Thus the manufacturing cost of the closure in minimized. When the sealing closure, with the container attached to it, is located relative to the reservoir, the slide cover can be opened and the toner transferred to the reservoir. In a second preferred embodiment of this invention, the container and closure are combined into a one-piece part that reduces the manufacturing cost even more, and further reduces the possibility of leakage.

The invention, and its objects and advantages, will become more apparent in the detailed description of the preferred embodiment presented below.

### BRIEF DESCRIPTION OF THE DRAWINGS

In the detailed description of the preferred embodiment of the invention, presented below, reference is made to the accompanying drawings, wherein:

FIG. 1a is a view, in perspective, of the container of the toner particle receptacle, according to this invention, for transporting and replenishing toner used in electrostatographic development stations;

FIG. 1b is a view, in perspective, of the toner particle receptacle container in FIG. 1a, but viewed from the opposite direction;

FIG. 2 is an exploded view, in perspective, of the closure an slide cover for closing and sealing the toner particle receptacle container shown in FIGS. 1a and 1b;

FIG. 3 is an exploded side elevational view of the closure and slide cover shown in FIG. 2;

FIG. 4 is a view, in perspective, of the closure and slide cover, with the slide cover partially inserted into the closure;

FIG. 5 is a view, in perspective, of the closure and slide cover, with the slide cover partially inserted into the closure, but viewed from the opposite direction as in FIG. 4;

FIG. 6 is an exploded view, in perspective, showing the relative orientation of the toner particle container, the closure, and the slide cover prior to their being assembled together;

FIG. 7 is a side elevational view of the toner particle container, with the closure and slide cover attached and sealed to the container;

FIG. 8 is a front elevational view, in cross-section, of the lower part of the container, closure, and slide cover assembly in FIG. 6;

FIG. 9a is a view, in perspective, of an alternative embodiment of the toner particle receptacle of this invention, including a container and closure produced as a single piece part; and

FIG. 9b is a view, in perspective, of the single-piece toner particle container and closure shown in FIG. 7a, but viewed from an opposite direction.

### DETAILED DESCRIPTION OF THE INVENTION

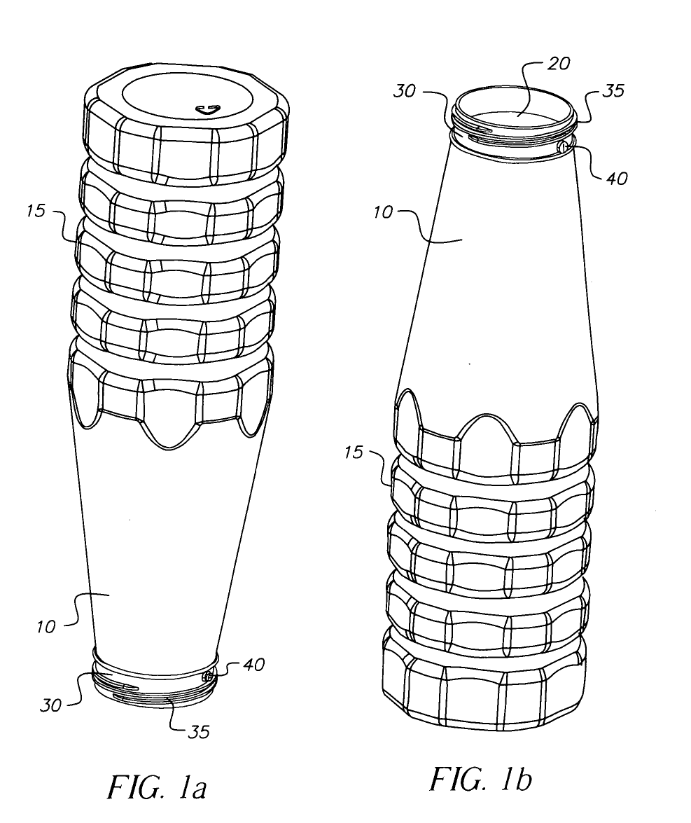

Referring now to the accompanying drawings, a first preferred embodiment of a replenishment receptacle, according to this invention shown in FIGS. 1-5. In FIGS. 1a and 1b, there is shown a toner particle container 10 from opposite directions, respectively. The preferred embodiment for the toner particle container 10 is, for example, an improvement on the toner particle container shown in co-pending U.S. patent application Ser. No. 09/835,611, filed on Apr. 16, 2001, in the names of Elich, et al. Toner particle container 10 may be made of polyethylene terephthalate by an injection stretch blow molding process, but it should be understood that the present invention is not limited to containers made of such material or by such process. Toner particle container 10 has ribs 15 for stiffening and improving the grip on the container, and an orifice 20 at one end, for filling and emptying of toner. A flange 30 encircles orifice 20. Flange 30 has outer threads 35 and two protrusions 40 adjacent to the threads 35. One of the two protrusions 40 is not visible in FIGS. 1a and 1b, it being located 180° opposite the visible protrusion 40.

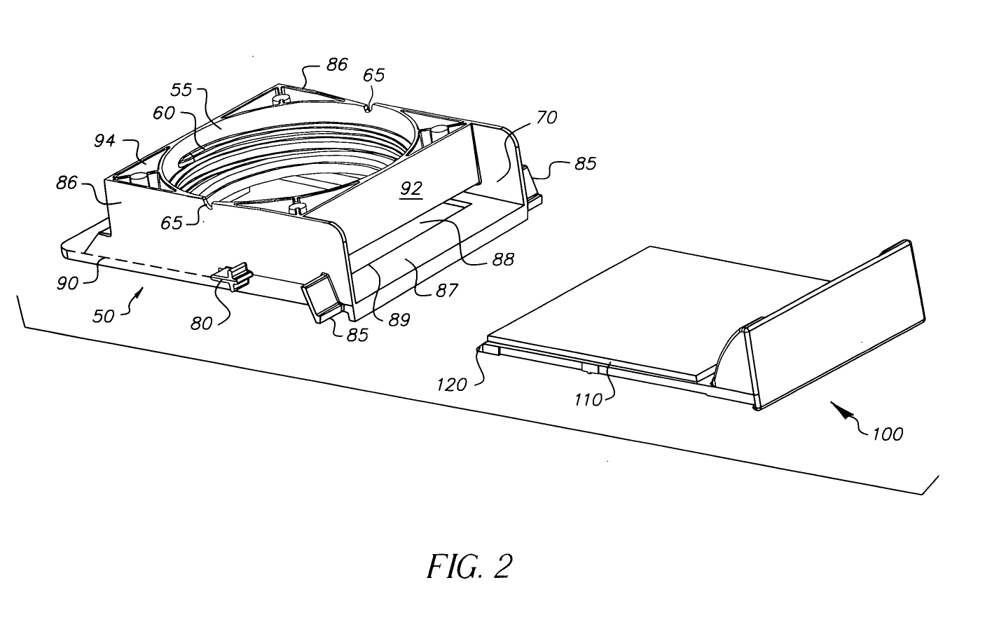

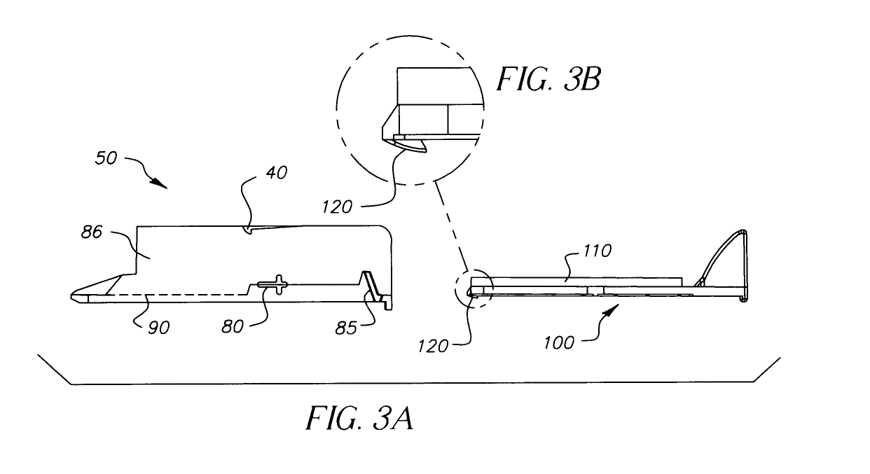

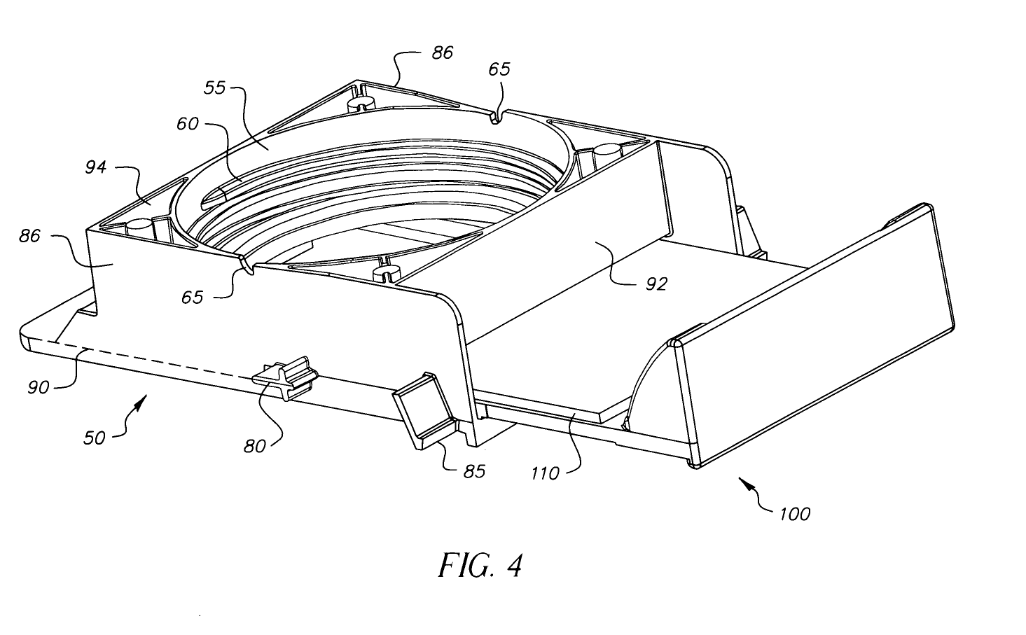

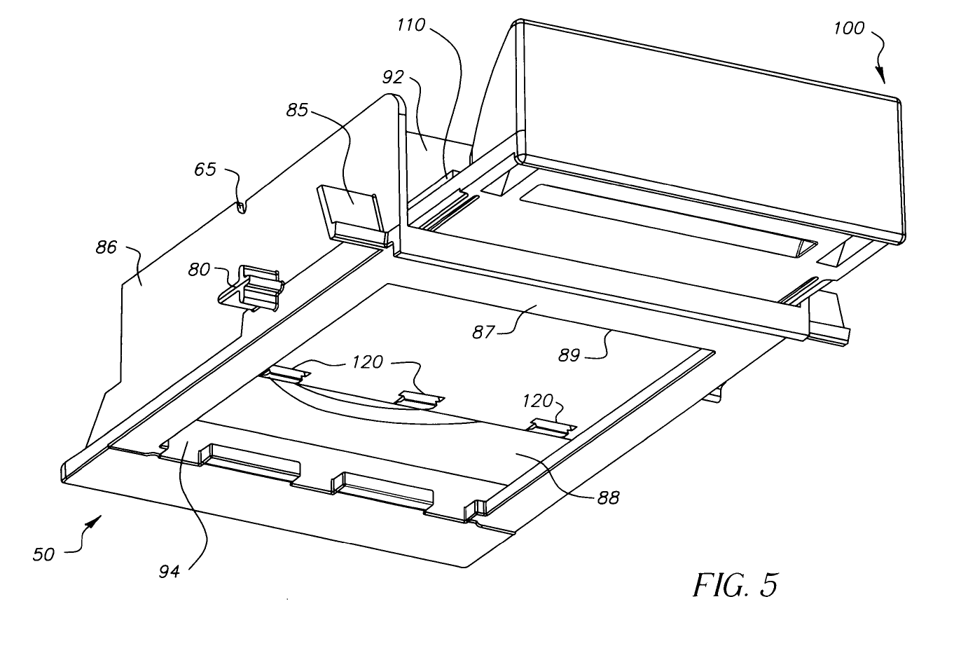

Referring now to FIGS. 2-5, there is shown two additional parts of the replenishment receptacle of this invention, namely, a closure 50 and a slide cover 100, for selectively closing and sealing toner particle container 10. FIG. 2 is an exploded view, in perspective, showing closure 50 and slide cover 100 separated. FIG. 3 is an exploded side elevational view of closure 50 and slide cover 100 separated. FIG. 4 is a view, in perspective showing slide cover 100 partially inserted into closure 50, from the side that would face toner container 10 when closure 50 and toner container 10 are connected. FIG. 5 is a view, in perspective, showing slide cover 100 partially inserted into closure 50, from the side that would face away from toner container 10 when closure 50 and container 10 are connected.

Closure 50 has an inner wall 55 with inner threads 60 for mating with outer threads 35 of toner particle container 10. Inner wall 55 also has two notches 65, which engage protrusions 40 of toner container 10 when toner particle container 10 is properly threaded fully into closure 50. When protrusions 40 engage respective notches 65, toner container 10 and closure 50 are locked together, thus preventing them from working loose and leaking during shipping and handling. However protrusions 40 and notches 65 have been shaped to enable container 10 and closure 50 to be detached, for example for recycling. Due to the shape of protrusions 40 and notches 65, when sufficient counterclockwise torque is applied, the container 10 will rotate relative to closure 50 with protrusions 40 popping out of the respective notches 65. The arrangement is provided such that the necessary torque can be applied by one of ordinary strength.

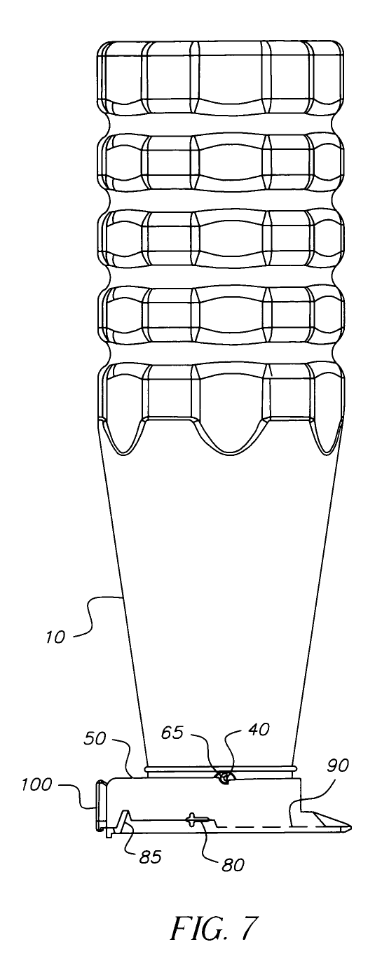

Closure 50 also has two opposite side walls 86 which are interconnected by an end face 87. Further, a pair of cross pieces 92 and 94, bounding inner wall 55 and spaced from end face 87, also interconnect side walls 86. As such, a groove 70 is formed to receive slide cover 100. An opening 88 in end face 87 is closed when slide cover 100 is fully inserted into groove 70 (see FIG. 7). After container 10 is filled with toner, closure 50, with slide cover 100 fully inserted into groove 70, is attached and locked to container 10 by threads 60 cooperating with threads 35, and notches 65 receiving protrusions 40, thus closing container 10. Slide cover 100 has a cellular urethane foam gasket 110 bonded to the side facing into toner particle container 10. Cellular urethane gasket 110 is compressible, and thus a seal to prevent leakage of toner is thereby formed between closure 50 and slide cover 100. Exemplary of cellular urethane foam material with the properties required of cellular urethane foam gasket 110 is PORON® 4701-50 produced by Rogers Corporation of Woodstock, Conn.

Closure 50 also has two sets of tab-like features 80 and 85, protruding from the outer surfaces of the two opposite side walls 86 (see FIG. 2 for example). The tab-like features 80 and 85 provide for locating closure 50, with toner particle container 10 attached thereto, to the electrostatographic reproduction apparatus reservoir, which is to receive the toner from toner particle container 10. When closure 50, with container 10 attached thereto, is located relative to the reservoir, slide cover 100 is pulled partially back out of groove 70, thereby enabling toner to be transferred from container 10 to the reservoir through opening 88. Ramp shaped features 120 protrude from the side of the slide cover 100 that is opposite the side to which gasket 110 is bonded. Due to the ramp shape of features 120 and the compressibility of cellular urethane gasket 110, slide cover 100 can be initially inserted into grooves 70 to close toner particle container 10, after toner particle container 10 is filled with toner. Thereafter slide cover 100 is prevented from being completely removed when slide cover 100 is slid back to transfer the toner to the reservoir. Slide cover 100 is prevented from being completely removed from groove 70 by ramp-shaped features 120 encountering edge 89 of opening 88. The function of ramp-shaped features 120 preventing complete removal of slide cover 100 from closure 50 is best seen from the view in FIG. 5. If slide cover 100 were completely removed during transfer of toner to the reservoir, toner would leak through groove 70.

Closure 50 may be injection molded out of plastic, but it should be understood that the present invention is not limited to a closure 50 made by that process or material. If closure 50 is made by an injection molding process, the cost can be minimized if a simple two-piece separable mold can be used. Tab-like features 80 and 85 are uniquely shaped and located to permit closure 50 to be injection molded in a simple two-piece separable mold. The mold separation line is shown as dotted line 90 in FIGS. 2-5.

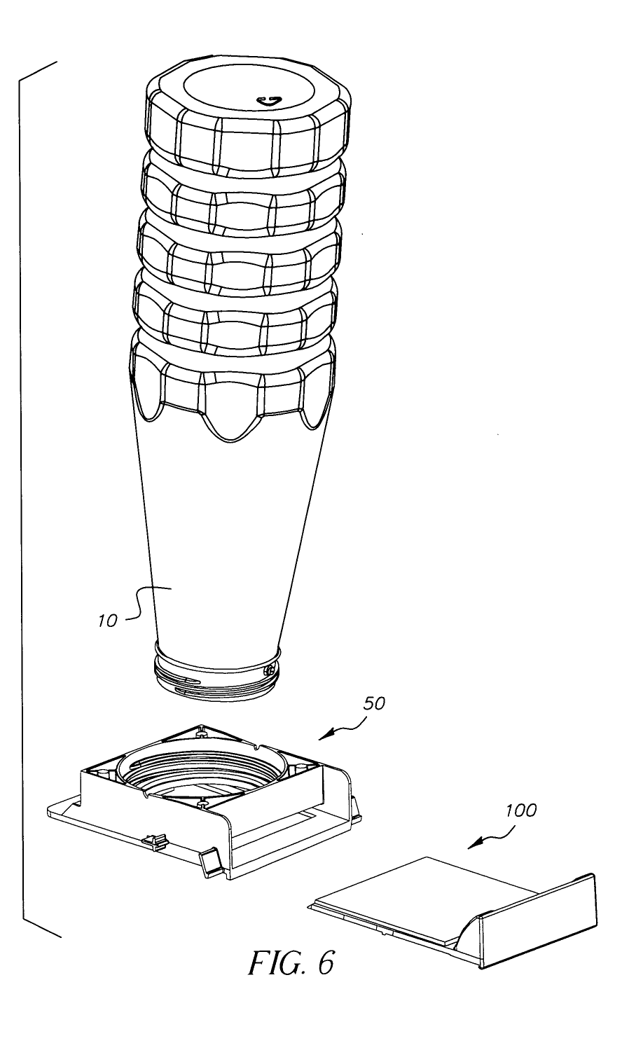

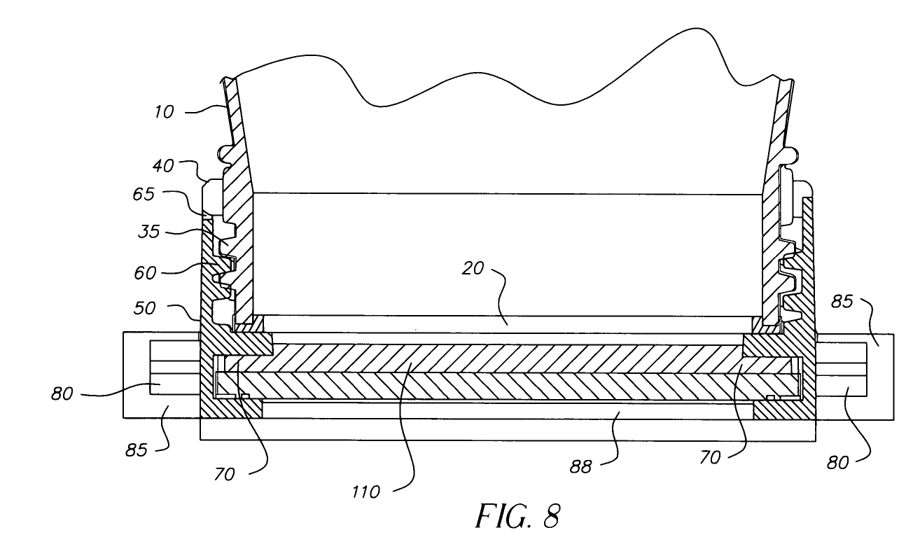

Referring to FIG. 6, there is shown toner container 10, closure 50, and slide cover 100 in their orientation, relative to each other, prior to their being fully inserted together and sealed. Referring to FIG. 7, there is shown a side elevation view of toner particle container 10 assembled to closure 50, with protrusion 40 in notch 65, and with slide cover 100 fully inserted into closure 50. Referring to FIG. 8, there is shown a cross section view of the lower part of the closed assembly shown in FIG. 7, including container 10, closure 50, and slide cover 100. FIG. 8 shows protrusion 40 locked in notch 65, container threads 35 and closure threads 60, and cellular urethane gasket 110 on slide cover 100 sealing orifice 20.

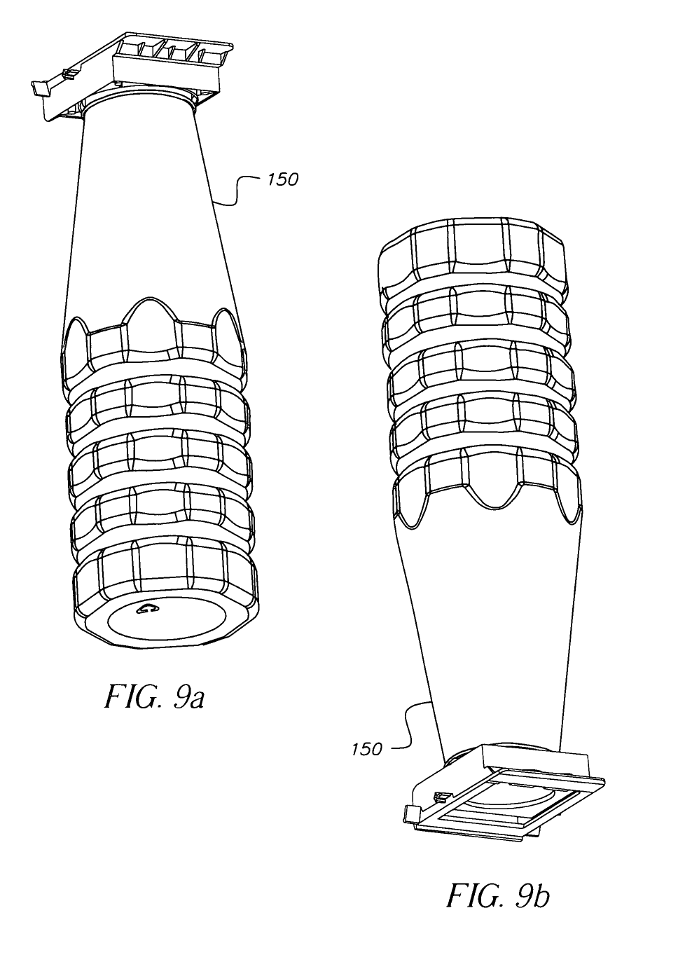

Another preferred embodiment of this invention is shown in FIGS. 9a and 9b. In this embodiment toner particle container 10 and closure 50 of the embodiment described above, with reference to FIGS. 1-8, are produced as a single-piece part, rather than as two separate parts. The single-piece part, designated by numeral 150, can, for example, be produced in a two-step process of injection molding the complete part, followed by blow molding the container section. This results in a significantly lower cost replenishment receptacle, according to the present invention. Slide cover 100, as described above, is used to close and seal single-piece receptacle 150, in the same manner as the two-piece embodiment.

The invention has been described in detail with particular reference to certain preferred embodiments thereof, but it will be understood that variations and modifications can be effected within the spirit and scope of the invention.

What is claimed is:

1. A replenishment receptacle for containing particulate material, and for facilitating replenishing the particulate material from said replenishment receptacle into a reservoir of an electrostatographic reproduction apparatus, said replenishment receptacle comprising:
a container including a chamber defining an orifice, said chamber capable of being filled with the particulate material through said orifice;
a closure connected to said container, said closure having inner surfaces adjacent to said orifice and outer surfaces opposite said inner surfaces, said outer surfaces having at least two tab-like features for locating said closure, with said container attached thereto, relative to the reservoir, said tab-like features positioned and shaped so that said closure may be produced by an injection molding process, including a mold having only two separable parts for ready removal of said closure, with said at least two tab-like features, from said mold; and
a cover, operatively connectable to said closure, for selectively closing said orifice after said container is filled with particulate material, and opening said orifice after said closure, with said container attached thereto, is located, by said at least two tab-like features, relative to the reservoir.

2. The replenishment receptacle of claim 1, wherein said container has at least one protrusion, and said closure defines at least one notch, wherein, when said closure is connected to said container, said at least one protrusion engages said at least one notch, thereby locking said closure to said container to prevent accidental separation of said closure from said container during shipping and handling.

3. The replenishment receptacle of claim 1, wherein said closure defines a groove and said cover slides into said groove.

4. The replenishment receptacle of claim 3, wherein said cover has an inner side, facing said orifice, and an outer side, opposite said inner side, said inner side having a cellular urethane foam gasket connected thereto, for sealing against flow of the particulate material past said cover, thereby preventing leakage of the particulate material from said container.

5. The replenishment receptacle of claim 4, wherein said outer side of said cover has at least one ramp-shaped protruding feature, which permits said cover to be inserted into said groove, but prevents said cover from being fully withdrawn from said groove after being inserted into said groove.

6. The replenishment receptacle of claim 4, wherein said cellular urethane foam gasket thickness is in the range of 0.1-0.2 inches thick and has density in the range 240-480 kg/cm³.

7. The replenishment receptacle of claim 6, wherein said cellular foam gasket includes a laminated polyester film with thickness in the range 0.001-0.002 inches.

8. A replenishment receptacle for containing particulate material, and for facilitating replenishing the particulate material from said replenishment receptacle into a reservoir of an electrostatographic reproduction apparatus, said replenishment receptacle comprising:
a container having a contiguous flange which defines an orifice in said container, for filling said container with particulate material, said flange having an inner surface facing said orifice and an outer surface opposite said inner surface, said outer surface having at least one protrusion;
a closure having an inner wall for mating with said flange, said inner wall defining at least one notch which engages with said at least one protrusion, thereby locking said closure to said container, said closure additionally having inner surfaces adjacent to said orifice and outer surfaces opposite said inner surfaces, said outer surfaces having at least two tab-like features for locating said closure, with said container attached thereto, relative to the reservoir, said tab-like features positioned and shaped so that said closure may be produced by an injection molding process, including a mold having only two separable parts, for ready removal of said closure, with said at least two tab-like features, from said mold; and
a cover, operatively connectable to said closure, for selectively closing said orifice after said container is filled with particulate material and opening said orifice after said closure, with said container attached thereto, is located, by said at least two tab-like features, relative to the reservoir.

9. The replenishment receptacle of claim 8, wherein said closure defines a groove and said cover slides into said groove.

10. The replenishment receptacle of claim 9, wherein said cover has an inner side, facing said orifice, and an outer side, opposite said inner side, said inner side having a cellular urethane foam gasket connected thereto, for sealing against flow of the particulate material past said cover, thereby preventing leakage of the particulate material from said container.

11. The replenishment receptacle of claim 10, wherein said outer side of said cover has at least one ramp-shaped protruding feature, which permits said cover to be inserted into said groove, but prevents said cover from being fully withdrawn from said groove after being inserted into said groove.

12. The replenishment receptacle of claim 10, wherein said cellular urethane foam gasket thickness is in the range of 0.1-0.2 inches thick and has density in the range 240-480 kg/cm³.

13. The replenishment receptacle of claim 12, wherein said cellular foam gasket includes a laminated polyester film with thickness in the range 0.001-0.002 inches.

14. A replenishment receptacle for containing particulate material, and for facilitating replenishing the particulate material from said replenishment receptacle into a reservoir of an electrostatographic reproduction apparatus, said replenishment receptacle comprising:
a container, defining an orifice, and capable of being filled with particulate material through said orifice, said orifice having sides protruding from said container, said sides having inner surfaces adjacent to said orifice, and outer surfaces opposite said inner surfaces, said outer surfaces having at least two protruding features for locating said container relative to the reservoir; and
a cover, operatively connectable to said container, for selectively closing said orifice after said container is filled with particulate material and for opening said orifice after said container is located relative to the reservoir.

15. The replenishment receptacle of claim 14, wherein said inner surfaces of said sides define a groove and said cover slides into said groove.

16. The replenishment receptacle of claim 15, wherein said cover has an inner side, facing said orifice, and an outer side, opposite said inner side, said inner side having a cellular urethane foam gasket connected thereto, for sealing against flow of the particulate material past said cover, thereby preventing leakage of the particulate material from said container.

17. The replenishment receptacle of claim 16, wherein said outer side of said cover has at least one ramp-shaped protruding feature, which permits said slide cover to be inserted into said groove, but prevents said slide cover from being fully withdrawn from said groove after being inserted into said groove.

18. The replenishment receptacle of claim 16, wherein said cellular urethane foam gasket thickness is in the range of 0.1-0.2 inches thick and has density in the range 240-480 kg/cm³.

19. The replenishment receptacle of claim 18, wherein said cellular foam gasket includes a laminated polyester film with thickness in the range 0.001-0.002 inches.
